(19) United States
(12) Patent Application Publication
(10) Pub. No.: US 2022/0211109 A1
(43) Pub. Date: Jul. 7, 2022

(54) An Aerosol Generating System, An Aerosol Generating Device And An Aerosol Generating Article

(71) Applicant: JT International S.A., Geneva (CH)

(72) Inventor: Mark Gill, London (GB)

(73) Assignee: JT International S.A., Geneva (CH)

(21) Appl. No.: 17/603,804

(22) PCT Filed: Jun. 10, 2020
(86) PCT No.: PCT/EP2020/066148

§ 371 Date: Oct. 14, 2021

(30) Foreign Application Priority Data
Jun. 13, 2019 (EP) 19179942.8

(51) Int. Cl. A24F 40/465; A24F 40/20; A24D 1/20; H05B 6/10; H05B 6/44

(52) U.S. Cl. CPC A24F 40/465; A24F 40/20; H05B 6/44; H05B 6/105; A24D 1/20

(57) ABSTRACT

An aerosol generating system includes an aerosol generating device and an aerosol generating article including aerosol generating material and an inductively heatable susceptor. The aerosol generating device includes: an electromagnetic field generator including a first planar coil and a second planar coil; a heating chamber for receiving the aerosol generating article, the heating chamber being positioned between the first and second planar coils and including an air inlet and an air outlet; and an airflow path extending between the air inlet and the air outlet.

### TECHNICAL FIELD

The present disclosure relates generally to an aerosol generating system and/or an aerosol generating device, and more particularly to an aerosol generating system and/or an aerosol generating device for use with an aerosol generating article to generate an aerosol for inhalation by a user. Embodiments of the present disclosure also relate to a plate-shaped aerosol generating article.

### TECHNICAL BACKGROUND

Devices which heat, rather than burn, an aerosol generating material to produce an aerosol for inhalation have become popular with consumers in recent years.

Such devices can use one of a number of different approaches to provide heat to the aerosol generating material. One such approach is to provide an aerosol generating device which employs an induction heating system and into which an aerosol generating article, comprising aerosol generating material, can be removably inserted by a user. In such a device, an induction coil is provided with the device and an inductively heatable susceptor is provided typically with the aerosol generating article. Electrical energy is supplied to the induction coil when a user activates the device which in turn generates an alternating electromagnetic field. The susceptor couples with the electromagnetic field and generates heat which is transferred, for example by conduction, to the aerosol generating material and an aerosol is generated as the aerosol generating material is heated.

Embodiments of the present disclosure seek to provide an improved aerosol generating system and device.

### SUMMARY OF THE DISCLOSURE

According to a first aspect of the present disclosure, there is provided an aerosol generating system comprising an aerosol generating device and an aerosol generating article including aerosol generating material and an inductively heatable susceptor, wherein the aerosol generating device comprises:
an electromagnetic field generator including a first planar coil and a second planar coil;
a heating chamber for receiving the aerosol generating article, the heating chamber being positioned between the first and second planar coils and including an air inlet and an air outlet; and
an airflow path extending between the air inlet and the air outlet.

According to a second aspect of the present disclosure, there is provided an aerosol generating device for heating an aerosol generating article including aerosol generating material and an inductively heatable susceptor, wherein the aerosol generating device comprises:
an electromagnetic field generator including a first planar coil and a second planar coil;
a heating chamber for receiving the aerosol generating article, the heating chamber being positioned between the first and second planar coils and including an air inlet and an air outlet; and
an airflow path extending between the air inlet and the air outlet.

The aerosol generating system/device is adapted to heat the aerosol generating material, without burning the aerosol generating material, to volatise at least one component of the aerosol generating material and thereby generate a vapour or aerosol for inhalation by a user of the aerosol generating system/device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

As used herein, the term “planar coil” means a spirally wound coil with a winding axis which is perpendicular to the surface in which the coil lies. The planar coils may lie in a flat plane. Thus, the planar coils may essentially be flat coils. The planar coils may lie on a curved plane. For example, the planar coils may be wound in a flat Euclidean plane and may thereafter be manipulated (e.g. bent) to lie on a curved plane.

The provision of an electromagnetic field generator comprising first and second planar coils allows the dimensions of the aerosol generating device to be minimised, in particular as compared to conventional aerosol generating devices which comprise an electromagnetic field generator that utilises a helical induction coil extending around the heating chamber.

The first and second planar coils may be arranged to generate electromagnetic fields that penetrate the heating chamber in different directions. This may provide improved coupling of the electromagnetic fields with the inductively heatable susceptor, thereby ensuring improved heating of the inductively heatable susceptor whilst maximising energy efficiency. Improved heating of the inductively heatable susceptor in turn leads to improved heating of the aerosol generating material, thereby maximising the amount of aerosol that is generated and providing an improved user experience.

The heating chamber may include an opening through which the aerosol generating article may be inserted into the heating chamber. The aerosol generating article can be easily inserted into, and removed from, the heating chamber via the opening. The aerosol generating article may be inserted into the heating chamber along a direction that is parallel with a longitudinal axis of the heating chamber.

The aerosol generating article may comprise a substantially cylindrical or rod-shaped aerosol generating article. The aerosol generating article may have any suitable cross section, e.g., a circular or elliptical cross section. Thus, the heating chamber may be arranged to receive a substantially cylindrical or rod-shaped aerosol generating article. The aerosol generating article can, thus, be manufactured using apparatus and methods that are used to manufacture conventional smoking articles having a cylindrical form. Further, the ability of the heating chamber to receive a substantially cylindrical or rod-shaped aerosol generating article is advantageous as, often, aerosol generating articles are packaged and sold in a cylindrical form. The aerosol generating article may include an integral filter through which a user may inhale an aerosol released upon heating. Thus, the device may be arranged to accommodate aerosol generating articles that include an integral filter.

The aerosol generating article may comprise an inductively heatable susceptor extending along the longitudinal axis or longitudinal direction thereof.

The inductively heatable susceptor may extend from a first end to a second end of the aerosol generating material.

The aerosol generating article may comprise a plurality of inductively heatable susceptors, each susceptor extending along the longitudinal axis or longitudinal direction thereof. Such an aerosol generating article may be easy to manufacture. Each susceptor may be provided in the form of a sheet or strip, which may give efficient heating and facilitate manufacture of the aerosol generating article.

The aerosol generating article may be substantially plate-shaped. The cross-section of the heating chamber may have major surfaces and side surfaces and the first and second planar coils may be positioned outwardly of the major surfaces of the heating chamber. With this arrangement, a larger proportion of the electromagnetic fields generated by the first and second planar coils penetrate the heating chamber and, hence, the major surfaces of the plate-shaped aerosol generating article allowing improved coupling of the electromagnetic fields with the inductively heatable susceptor and, hence, ensuring improved heating of the inductively heatable susceptor. The plate-shaped form of the aerosol generating article also ensures that the inductively heatable susceptor is located close to the first and second planar coils which further ensures improved coupling of the electromagnetic fields with the inductively heatable susceptor and maximises energy input into the inductively heatable susceptor. The use of a plate-shaped aerosol generating article also allows the dimensions of the aerosol generating system/device to be minimised to provide a compact system/device.

The aerosol generating device may be arranged to accommodate aerosol generating articles (e.g. plate-shaped aerosol generating articles) which do not include an integral filter and, thus, the aerosol generating device may further comprise a mouthpiece.

The inductively heatable susceptor may include a major surface which may be parallel with the major surfaces of the heating chamber. The major surface is easily penetrated by a larger proportion of the electromagnetic fields generated by the first and/or second planar coils thereby ensuring improved coupling of the generated electromagnetic fields with the inductively heatable susceptor and, hence, improved heating of the inductively heatable susceptor.

The heating chamber may include projections or grooves for supporting the aerosol generating article in the heating chamber and for providing said airflow path around a surface of the aerosol generating article between the air inlet and the air outlet. The airflow path ensures that vapour and/or aerosol generated during use of the aerosol generating system/device can flow easily through the heating chamber for delivery to the air outlet and to the user, for example through a mouthpiece which may be positioned at the air outlet.

The electromagnetic field generator may include at least three planar coils that surround the heating chamber. The planar coils may be activated sequentially. Each of the planar coils may be arranged to generate an electromagnetic field that penetrates the heating chamber in a different direction from the other planar coils. The major faces of the inductively heatable susceptor are penetrated by, and coupled with, the electromagnetic fields generated by the planar coils. With this arrangement, the efficiency of energy coupling can be improved even if the inductively heatable susceptor is randomly oriented.

The heating chamber may have a curved cross-sectional shape and the planar coils may lie on a curved plane surrounding the heating chamber. The major faces of the inductively heatable susceptor are penetrated by, and coupled with, the electromagnetic fields generated by the planar coils. This arrangement may be particularly suited to embodiments in which the aerosol generating article has a curved cross-sectional shape, e.g. circular or elliptical, and/or in which the inductively heatable susceptor is randomly oriented.

The aerosol generating device may include a power source and a may include a controller.

Electrical power may be supplied alternately to the first and second planar coils. The electromagnetic field generator may be configured to supply electrical power alternately to the first and second planar coils. For example, the controller may be configured to supply electrical power from the power source alternately to the first and second planar coils. The first and second planar coils may be connected by a center tap and electrical power may be supplied alternately to the first and second planar coils. This allows the first and second planar coils to be activated alternately (i.e. one at a time) to provide a desired heating effect.

The second planar coil may include a capacitor, electrical power may be supplied intermittently to the first planar coil and the first and second planar coils may be arranged to face each other. This arrangement constrains the electromagnetic fields generated by the first and second planar coils and reduces electromagnetic leakage. This in turn strengthens the current and electromagnetic fields generated during use of the system/device.

The second planar coil may include a capacitor and the aerosol generating device may include an electromagnetic shield positioned between the second planar coil and an outer cover. This arrangement further helps to reduce electromagnetic leakage.

The first and second planar coils may each include a first electrode and a second electrode. The first electrode may be connected to an outer end of the first and second planar coils and the second electrode may be connected to an inner end of the first and second planar coils. The first and second planar coils may be wound in the same direction from the first electrode to the second electrode, e.g. a clockwise direction or an anti-clockwise direction, about a winding axis perpendicular to a surface in which each coil lies and viewed from the same position outside the heating chamber. The first and second coils may be wound in opposite directions from the first electrode to the second electrode, e.g. a clockwise direction or an anti-clockwise direction, about a winding axis perpendicular to a surface in which each coil lies and viewed from the same position outside the heating chamber.

In a first arrangement, the electromagnetic field generator may be configured to supply electrical power to the first and second planar coils to cause current to flow in the first and second planar coils in opposite directions, and in particular in opposite directions between the first and second electrode of each planar coil. For example, the controller may be configured to supply electrical power from the power source to the first and second planar coils to cause current to flow in the first and second planar coils in opposite directions, and in particular in opposite directions between the first and second electrode of each planar coil. The opposite direction of the current flow within each planar coil may provide improved heating of the inductively heatable susceptor, by generating electromagnetic fields in the first and second planar coils in which the major direction of the electromagnetic field generated by the first planar coil at the axis of the first planar coil in the plane where the first planar coil lies is opposite to the major direction of the electromagnetic field generated by the second planar coil at the axis of the second planar coil in the plane where the second planar coil lies. The opposite direction of the current flow within each planar coil may also provide for increased heat generation within the inductively heatable susceptor when it is formed from a magnetic material, by increasing the magnetic losses within the inductively heatable susceptor.

In a first example of the first arrangement, the first and second planar coils may be wound in opposite directions from the first electrode to the second electrode about a winding axis perpendicular to a surface in which each coil lies and viewed from the same position outside the heating chamber and the first electrodes of the first and second planar coils may be connected by a center tap. The second electrodes of the first and second planar coils may be connected to one or more switching devices, e.g. field-effect transistors (FETs), such as a metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in an anti-clockwise direction from the first electrode to the second electrode about the same winding axis and viewed from the same position outside the heating chamber. In this example, current flows in the first planar coil from the first electrode to the second electrode (i.e. in a clockwise direction) and in the second planar coil from the first electrode to the second electrode (i.e. in an anti-clockwise direction).

In a second example of the first arrangement, the first and second planar coils may be wound in opposite directions from the first electrode to the second electrode about a winding axis perpendicular to a surface in which each coil lies and viewed from the same position outside the heating chamber and the second electrodes of the first and second planar coils may be connected by a center tap. The first electrodes of the first and second planar coils may be connected to one or more switching devices, e.g. field-effect transistors (FETs), such as metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in an anti-clockwise direction from the first electrode to the second electrode about the same winding axis and viewed from the same position outside the heating chamber. In this example, current flows in the first planar coil from the second electrode to the first electrode (i.e. in an anti-clockwise direction) and in the second planar coil from the second electrode to the first electrode (i.e. in a clockwise direction).

In a third example of the first arrangement, the first and second planar coils may be wound in the same direction from the first electrode to the second electrode about a winding axis perpendicular to a surface in which each coil lies and viewed from the same position outside the heating chamber and the first electrode of the first planar coil and the second electrode of the second planar coil may be connected by a center tap. The second electrode of the first planar coil and the first electrode of the second planar coil may be connected to one or more switching devices, e.g. field-effect transistors (FETs), such as metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in a clockwise direction from the first electrode to the second electrode about the same winding axis and viewed from the same position outside the heating chamber. In this example, current flows in the first planar coil from the first electrode to the second electrode (i.e. in a clockwise direction) and in the second planar coil from the second electrode to the first electrode (i.e. in an anti-clockwise direction).

In a second arrangement, the electromagnetic field generator may be configured to supply electrical power to the first and second planar coils to cause current to flow in the first and second planar coils in the same direction, and in particular in the same direction between the first and second electrode of each planar coil. For example, the controller may be configured to supply electrical power from the power source to the first and second planar coils to cause current to flow in the first and second planar coils in the same direction, and in particular in the same direction between the first and second electrode of each planar coil.

In a first example of the second arrangement, the first and second planar coils may be wound in the same direction from the first electrode to the second electrode about a winding axis perpendicular to a surface in which each coil lies and viewed from the same position outside the heating chamber and the first electrodes of the first and second planar coils may be connected by a center tap. The second electrodes of the first and second planar coils may be connected to one or more switching devices, e.g. field-effect transistors (FETs), such as metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in a clockwise direction from the first electrode to the second electrode about the same winding axis and viewed from the same position outside the heating chamber. In this example, current flows in the first planar coil from the first electrode to the second electrode (i.e. in a clockwise direction) and in the second planar coil from the first electrode to the second electrode (i.e. in a clockwise direction).

In a second example of the second arrangement, the first and second planar coils may be wound in the same direction from the first electrode to the second electrode about a winding axis perpendicular to a surface in which each coil lies and viewed from the same position outside the heating chamber and the second electrodes of the first and second planar coils may be connected by a center tap. The first electrodes of the first and second planar coils may be connected to one or more switching devices, e.g. field-effect transistors (FETs), such as metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in a clockwise direction from the first electrode to the second electrode about the same winding axis and viewed from the same position outside the heating chamber. In this example, current flows in the first planar coil from the second electrode to the first electrode (i.e. in an anti-clockwise direction) and in the second planar coil from the second electrode to the first electrode (i.e. in an anti-clockwise direction).

In a third example of the second arrangement, the first and second planar coils may be wound in opposite directions from the first electrode to the second electrode about a winding axis perpendicular to a surface in which each coil lies and viewed from the same position outside the heating chamber and the first electrode of the first planar coil and the second electrode of the second planar coil may be connected by a center tap. The second electrode of the first planar coil and the first electrode of the second planar coil may be connected to one or more switching devices, e.g. field-effect transistors (FETs), such as metal-oxide-semiconductor field-effect transistors (MOSFETs). The first planar coil may be wound in a clockwise direction from the first electrode to the second electrode about a winding axis perpendicular to a surface in which the coil lies and viewed from a position outside the heating chamber and the second planar coil may be wound in an anti-clockwise direction from the first electrode to the second electrode about the same winding axis and viewed from the same position outside the heating chamber. In this example, current flows in the first planar coil from the first electrode to the second electrode (i.e. in a clockwise direction) and in the second planar coil from the second electrode to the first electrode (i.e. in a clockwise direction).

The planar coils may be arranged to operate in use with a fluctuating electromagnetic field having a magnetic flux density of between approximately 20 mT and approximately 2.0 T at the point of highest concentration.

The power source and the controller may be configured to operate at a high frequency.

The power source and controller may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The planar coils may comprise a Litz wire or a Litz cable. It will, however, be understood that other materials may be used to manufacture the planar coils.

The inductively heatable susceptor may comprise one or more, but not limited, of aluminium, iron, nickel, stainless steel and alloys thereof, e.g. Nickel Chromium or Nickel Copper. With the application of an electromagnetic field in its vicinity, the inductively heatable susceptor generates heat due to eddy currents and/or magnetic hysteresis losses resulting in a conversion of energy from electromagnetic to heat.

The aerosol generating material may be any type of solid or semi-solid material. Example types of aerosol generating solids include powder, granules, pellets, shreds, strands, particles, gel, strips, loose leaves, cut filler, porous material, foam material or sheets. The aerosol generating material may comprise plant derived material and in particular, may comprise tobacco.

The foam material may comprise a plurality of fine particles (e.g. tobacco particles) and can also comprise a volume of water and/or a moisture additive, such as a humectant. The foam material may be porous, and may allow a flow of air and/or vapour through the foam material.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of between approximately 10% and approximately 20% on a dry weight basis, and possibly approximately 15% on a dry weight basis.

Upon heating, the aerosol generating material may release volatile compounds. The volatile compounds may include nicotine or flavour compounds such as tobacco flavouring.

According to a third aspect of the present disclosure, there is provided a plate-shaped aerosol generating article comprising aerosol generating material and an inductively heatable susceptor positioned in the aerosol generating material.

The plate-shaped aerosol generating article is particularly suitable for use with embodiments of the aerosol generating system/device defined above. In preferred embodiments, the aerosol generating material comprises a foam material or one or more aerosol generating sheets.

The inductively heatable susceptor may comprise a substantially planar susceptor element formed as an endless loop which lies in a flat plane. That is, the susceptor element may be formed as an endless loop in a direction that is parallel to the surface in which the susceptor element lies. The inductively heatable susceptor could advantageously comprise a plurality of said planar susceptor elements each formed as an endless loop. The plurality of planar susceptor elements could be distributed throughout the aerosol generating material, for example in the same plane.

The surface in which the or each susceptor element lies may be parallel to major surfaces of the aerosol generating article. Manufacture of the aerosol generating article is thereby facilitated.

In one embodiment, the or each loop may be polygonal, for example rectangular or square. In another embodiment, the or each loop may be curved and may, for example, comprise a loop with an oval or circular form.

The inductively heatable susceptor may comprise a plurality of strips of susceptor material. Each strip typically has two parallel major faces and two end faces. The strips may be arranged so that their major faces are substantially parallel to major surfaces of the aerosol generating article. The strips may be aligned with each other within the aerosol generating material such that the normal to a major face of each sheet or strip is directed in substantially the same direction. The strips may be spaced apart in the same plane between major edges of the aerosol generating article and/or may be arranged in multiple planes between major surfaces of the aerosol generating article. The use of susceptor strips may provide efficient heating and/or facilitate manufacture of the aerosol generating article.

The inductively heatable susceptor may comprise a particulate susceptor material. The use of particulate susceptor material may provide efficient heating and/or facilitate manufacture of the aerosol generating article.

### BRIEF DESCRIPTION OF THE DRAWINGS

FIG. 1 is a diagrammatic side view of a first example of an aerosol generating system;

FIG. 2 is a cross-sectional view along the line A-A in FIG. 1;

FIGS. 3 to 8 are diagrammatic cross-sectional views of various examples of plate-shaped aerosol generating articles for use with the first example of the aerosol generating system illustrated in FIGS. 1 and 2, in which FIGS. 3b to 8b are cross-sectional views respectively along the line A-A of FIGS. 3a to 8a and FIGS. 3a to 8a are also cross-sectional views of each plate-shaped aerosol generating article;

FIG. 9 is a diagrammatic side view of a second example of an aerosol generating system;

FIGS. 10 to 12 are cross-sectional views along the line A-A in FIG. 9 of alternative configurations of the second example of the aerosol generating system;

FIGS. 13a to 13d are diagrammatic views of a first electrical arrangement of first and second planar coils, in which FIG. 13a is a cross-sectional view along the line A-A in FIG. 13b, FIG. 13b is a view in the direction of arrow B in FIG. 13a, and FIG. 13c and FIG. 13d are perspective and side views respectively with an aerosol generating article positioned between first and second planar coils; and

FIGS. 14a to 14d are diagrammatic views of a second electrical arrangement of first and second planar coils, in which FIG. 14a is a cross-sectional view along the line A-A in FIG. 14b, FIG. 14b is a view in the direction of arrow B in FIG. 14a, and FIG. 14c and FIG. 14d are perspective and side views respectively with an aerosol generating article positioned between first and second planar coils.

### DETAILED DESCRIPTION OF EMBODIMENTS

Embodiments of the present disclosure will now be described by way of example only and with reference to the accompanying drawings.

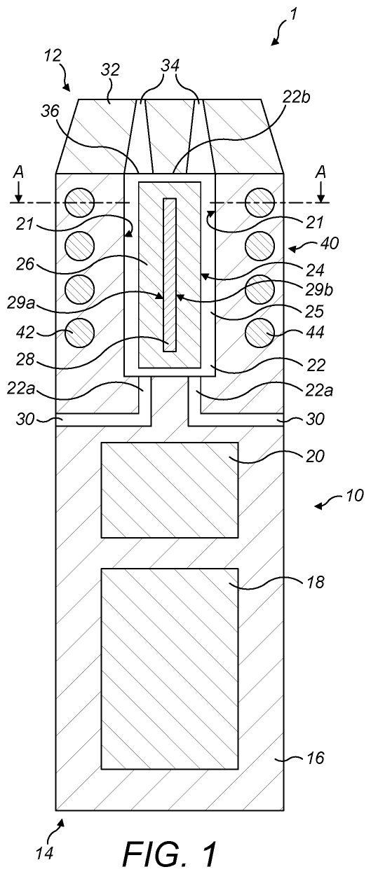

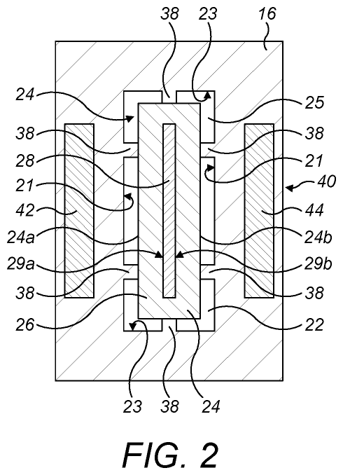

Referring initially to FIGS. 1 and 2, there is shown diagrammatically a first embodiment of an aerosol generating system 1. The aerosol generating system 1 comprises an aerosol generating device 10 and an aerosol generating article 24. The aerosol generating device 10 has a proximal end 12 and a distal end 14 and comprises a device body 16 which includes a power source 18 and a controller 20 which may be configured to operate at high frequency. The power source 18 typically comprises one or more batteries which could, for example, be inductively rechargeable.

The aerosol generating device 10 comprises a heating chamber 22 having air inlets 22a and an air outlet 22b. The heating chamber 22 is positioned at the proximal end 12 of the aerosol generating device 10 and is arranged to receive a plate-shaped aerosol generating article 24 including an aerosol generating material 26 and an inductively heatable susceptor 28. The aerosol generating article 24 is a disposable article 24 which may, for example, contain tobacco as the aerosol generating material 26. The heating chamber 22 is rectangular when viewed in cross-section as best seen in FIG. 2 so that it can receive the plate-shaped aerosol generating article 24. The heating chamber 22 has major surfaces 21 and side surfaces 23.

The aerosol generating device 10 includes a plurality of air inlets 30 to deliver air to the air inlets 22a of the heating chamber 22. The aerosol generating device 10 also comprises a mouthpiece 32 which is removably mountable on the device body 16 at the proximal end 12 and through which a user may inhale an aerosol generated during use of the device 10. The mouthpiece 32 includes air outlets 34 which allow aerosol generated during use of the device 10 to flow from the heating chamber 22 via the air outlet 22b of the heating chamber 22 and into the mouth of a user.

The heating chamber 22 includes an opening 36, accessible by removal of the mouthpiece 32, through which a user can insert an aerosol generating article 24 into, and remove an aerosol generating article 24 from, the heating chamber 22 in a direction which is parallel with a longitudinal axis of the heating chamber 22. In the illustrated embodiment, the opening 36 of the heating chamber 22 also serves as the air outlet 22b of the heating chamber 22. The heating chamber 22 includes a plurality of projections 38 which extend from the major surfaces 21 and the side surfaces 23. The projections 38 support an aerosol generating article 24 in the heating chamber 22 and create a space between the aerosol generating article 24 and the major surfaces 21 and side surfaces 23, thereby providing an air flow path 25 around a surface of the aerosol generating article 24 between the air inlet 22a and the air outlet 22b of the heating chamber 22.

The aerosol generating device 10 comprises an electromagnetic field generator 40 including a first planar coil 42 and a second planar coil 44. In the embodiment illustrated in FIGS. 1 and 2, the first and second planar coils 42, 44 are flat coils positioned on opposite sides of the heating chamber 22 and outwardly of the major surfaces 21. The first and second planar coils 42, 44 are arranged to generate electromagnetic fields that penetrate the heating chamber 22 in different directions, thus allowing improved coupling of the electromagnetic fields with the inductively heatable susceptor 28. The inductively heatable susceptor 28 includes major surfaces 29a, 29b which are parallel with the major surfaces 21 of the heating chamber 22 and, hence, with the first and second planar coils 42, 44, thereby ensuring that the major surfaces 29a, 29b are easily penetrated by, and coupled with, the electromagnetic fields generated by the first and second planar coils 42, 44.

The first and second planar coils 42, 44 can be energised by the power source 18 and controller 20. The controller 20 may include, amongst other electronic components, an inverter which is arranged to convert a direct current from the power source 18 into an alternating high-frequency current for the first and second planar coils 42, 44. When the first and second planar coils 42, 44 are energised by the alternating high-frequency current, alternating and time-varying electromagnetic fields are produced that penetrate the heating chamber 22 in different directions. The electromagnetic fields couple with the inductively heatable susceptor 28 and generate eddy currents and/or hysteresis losses in the inductively heatable susceptor 28 causing it to heat up. The heat is then transferred from the inductively heatable susceptor 28 to the aerosol generating material 26, for example by conduction, radiation and convection.

The heat transferred from the inductively heatable susceptor 28 to the aerosol generating material 26 causes it to heat up and thereby produce a vapour or aerosol. The aerosolisation of the aerosol generating material 26 is facilitated by the addition of air from the surrounding environment through the air inlets 30, 22a which flows through the heating chamber 22 along the airflow path 25 around the outer surface of the aerosol generating article 24. The aerosol generated by heating the aerosol generating material 26 then exits the heating chamber 22, through the air outlets 22b, 34, and is inhaled by a user of the device 10 through the mouthpiece 32. It will be understood that the flow of air through the heating chamber 22, i.e. from the air inlets 30, 22a through the heating chamber 22 and out of the air outlets 22b, 34, can be aided by negative pressure created by a user drawing air from the outlet side of the device 10 using the mouthpiece 32.

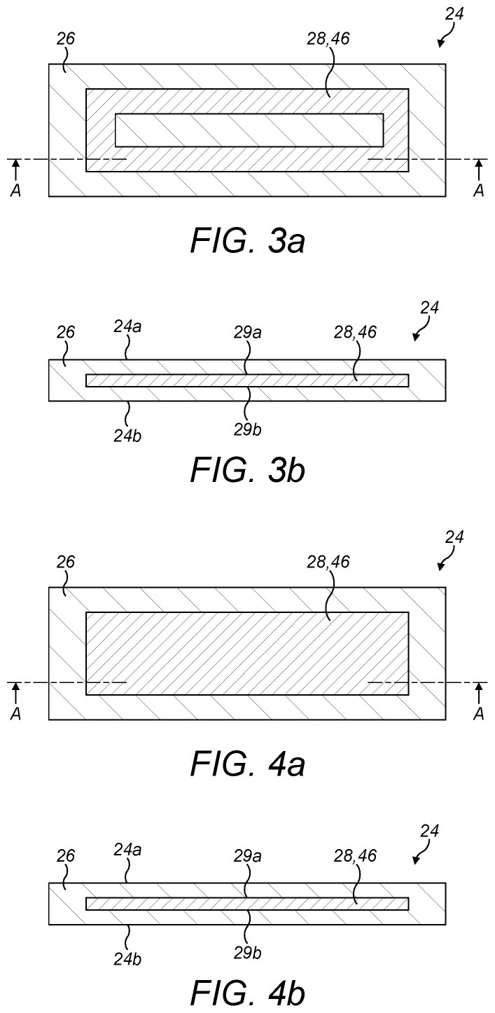

Various examples of plate-shaped aerosol generating articles 24 for use with the aerosol generating device 10 are illustrated in FIGS. 3 to 8 and will now be described in further detail.

In FIGS. 3a and 3b, the aerosol generating article 24 includes an inductively heatable susceptor 28 in the form of a substantially planar susceptor element 46 positioned in the aerosol generating material 26. The susceptor element 46 is formed as an endless rectangular loop. As will be apparent from FIG. 3b, the surface in which the susceptor element 46 lies is substantially parallel to major surfaces 24a, 24b of the aerosol generating article 24. Thus, the major surfaces 29a, 29b of the inductively heatable susceptor 28 are substantially parallel to the major surfaces 24a, 24b of the aerosol generating article 24.

In FIGS. 4a and 4b, the aerosol generating article 24 includes an inductively heatable susceptor 28 in the form of a substantially plate-shaped susceptor element 46 positioned in the aerosol generating material 26. The major surfaces 29a, 29b of the inductively heatable susceptor 28 are substantially parallel to the major surfaces 24a, 24b of the aerosol generating article 24.

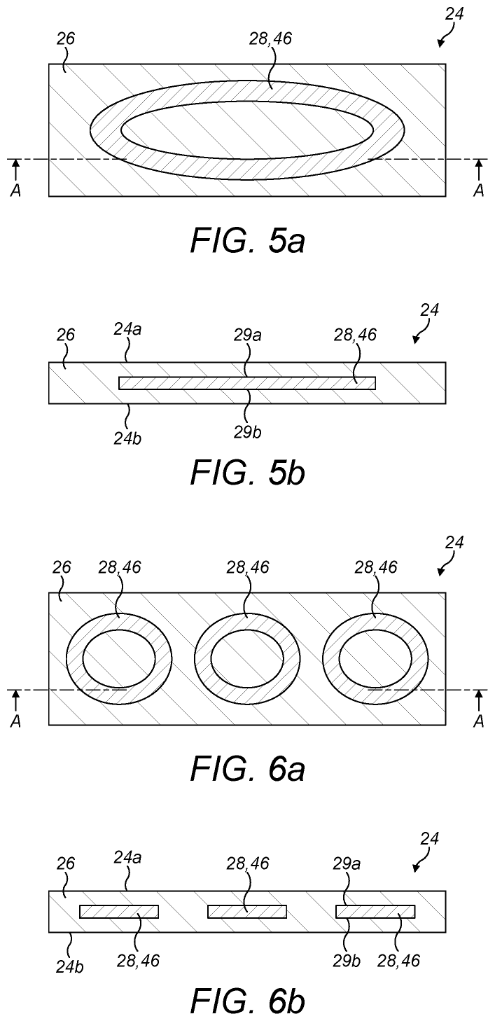

In FIGS. 5a and 5b, the aerosol generating article 24 includes an inductively heatable susceptor 28 in the form of a substantially planar susceptor element 46 positioned in the aerosol generating material 26. The susceptor element 46 is formed as an endless elliptical (e.g. oval) loop. As will be apparent from FIG. 5b, the surface in which the susceptor element 46 lies is substantially parallel to major surfaces 24a, 24b of the aerosol generating article 24. Thus, the major surfaces 29a, 29b of the inductively heatable susceptor 28 are substantially parallel to the major surfaces 24a, 24b of the aerosol generating article 24.

In FIGS. 6a and 6b, the aerosol generating article 24 includes an inductively heatable susceptor 28 in the form of a plurality of substantially planar susceptor elements 46 positioned in the aerosol generating material 26. Each susceptor element 46 is formed as an endless circular loop. As will be apparent from FIG. 6b, the surface in which the susceptor elements 46 lie is substantially parallel to major surfaces 24a, 24b of the aerosol generating article 24. Thus, the major surfaces 29a, 29b of the inductively heatable susceptor 28 are substantially parallel to the major surfaces 24a, 24b of the aerosol generating article 24.

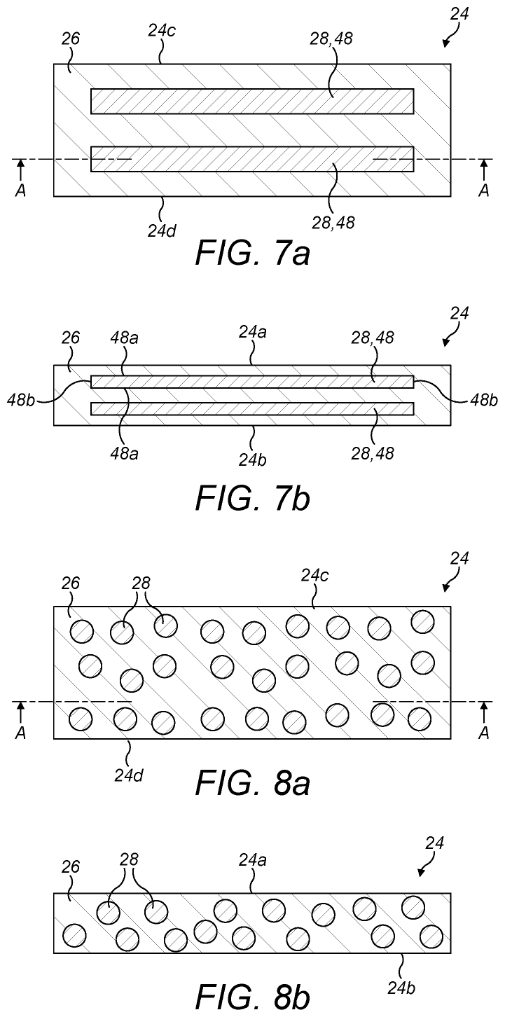

In FIGS. 7a and 7b, the aerosol generating article 24 includes an inductively heatable susceptor 28 in the form of a plurality of strips 48 of susceptor material positioned in the aerosol generating material 26. Each strip 48 has two substantially parallel major faces 48a and two end faces 48b. The strips 48 are aligned with each other within the aerosol generating material 26 and are arranged so that their major faces 48a are substantially parallel to major surfaces 24a, 24b of the aerosol generating article 24. The strips 48 are distributed throughout the aerosol generating material 26, and in particular are spaced apart in substantially the same plane between major edges 24c, 24d of the aerosol generating article 24 (best seen in FIG. 7a) and arranged in multiple planes between major surfaces 24a, 24b of the aerosol generating article (best seen in FIG. 7b).

In FIGS. 8a and 8b, the inductively heatable susceptor 28 comprises a particulate susceptor material which is distributed throughout the aerosol generating material 26, between the major edges 24c, 24d of the aerosol generating article 24 (best seen in FIG. 8a) and between the major surfaces 24a, 24b of the aerosol generating article 24 (best seen in FIG. 8b).

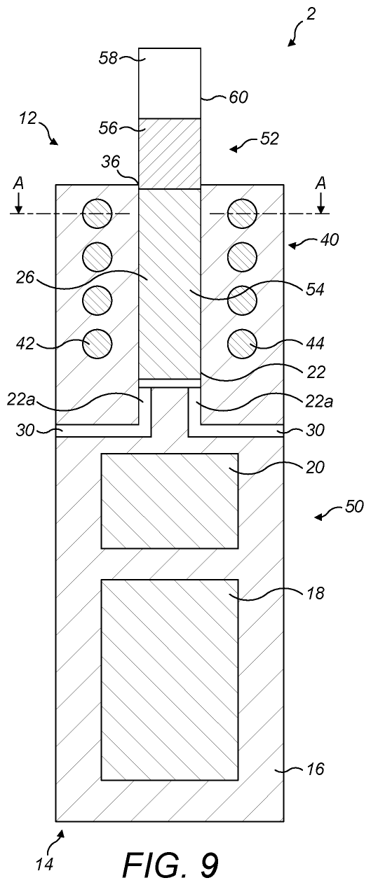

Referring now to FIGS. 9 to 12, there is shown diagrammatically a second embodiment of an aerosol generating system 2. The aerosol generating system 2 comprises an aerosol generating device 50 which is similar to the aerosol generating device 10 described above and in which corresponding elements are identified using the same reference numerals.

The heating chamber 22 has a curved cross-sectional shape and in the illustrated embodiment has a circular cross-section which is adapted to receive a cylindrical or rod-shaped aerosol generating article 52 having a corresponding circular cross-section. The aerosol generating article 52 includes a body 54 of aerosol generating material 26, a hollow tubular member 56 positioned downstream of the body 54 of aerosol generating material 26 and a filter 58, for example comprising cellulose acetate fibres, positioned downstream of the tubular member 56. The body 54 of aerosol generating material 26, the tubular member 56 and the filter 58 are wrapped by a sheet of material, for example a paper wrapper 60, to maintain the positional relationship between component parts of the aerosol generating article 52.

The aerosol generating article 52 includes an inductively heatable susceptor (not shown) positioned in the aerosol generating material 26. The inductively heatable susceptor may extend along the longitudinal axis or longitudinal direction of the aerosol generating article 52, for example from a first end to a second end, and may comprise a sheet or strip. The inductively heatable susceptor could comprise a tubular susceptor or particulate susceptor material distributed throughout the aerosol generating material 26.

The aerosol generating article 52 is positioned in the heating chamber 22 by inserting the body 54 of aerosol generating material 26 into the heating chamber 22 via the opening 36. The heating chamber 22 and aerosol generating article 52 are dimensioned so that the filter 58 projects from the heating chamber 22 at the proximal end 12 of the aerosol generating device 50.

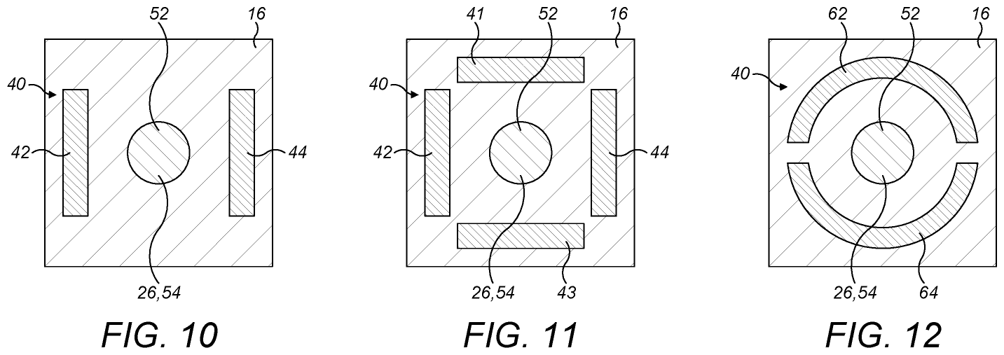

In a first configuration shown in FIG. 10, the aerosol generating device 50 includes an electromagnetic field generator 40 as described above with reference to FIGS. 1 and 2. Thus, the electromagnetic field generator 40 includes first and second planar coils 42, 44 positioned on opposite sides of the heating chamber 22 which are arranged to generate electromagnetic fields that penetrate the heating chamber 22 in different directions.

In a second configuration shown in FIG. 11, the aerosol generating device 50 includes an electromagnetic field generator 40 similar to that described above with reference to FIGS. 1 and 2 but comprising four planar coils 41, 42, 43, 44 positioned around the heating chamber 22. In this configuration, each of the planar coils 41, 42, 43, 44 is arranged to generate an electromagnetic field that penetrates the heating chamber 22 in different a direction from the other planar coils. In some embodiments, the planar coils 41, 42, 43, 44 may be activated sequentially by the controller 20. The controller 20 may advantageously activate the planar coils in the sequence 41:43:42:44, although it will be understood by one of ordinary skill in the art that any sequence may be adopted.

In a third configuration shown in FIG. 12, the aerosol generating device 50 includes an electromagnetic field generator 40 including first and second planar coils 62, 64 that lie on a curved plane which surrounds the heating chamber 22 and which follows the contour of the heating chamber 22. The first and second planar coils 62, 64 are arranged to generate electromagnetic fields that penetrate the heating chamber 22 in different directions and may be formed by winding the coils in a flat Euclidean plane and thereafter bending the coils to lie on a curved plane.

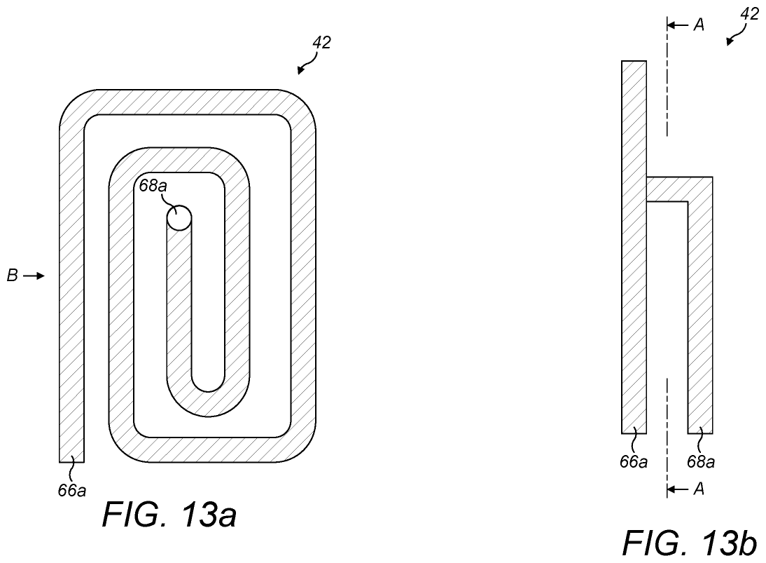

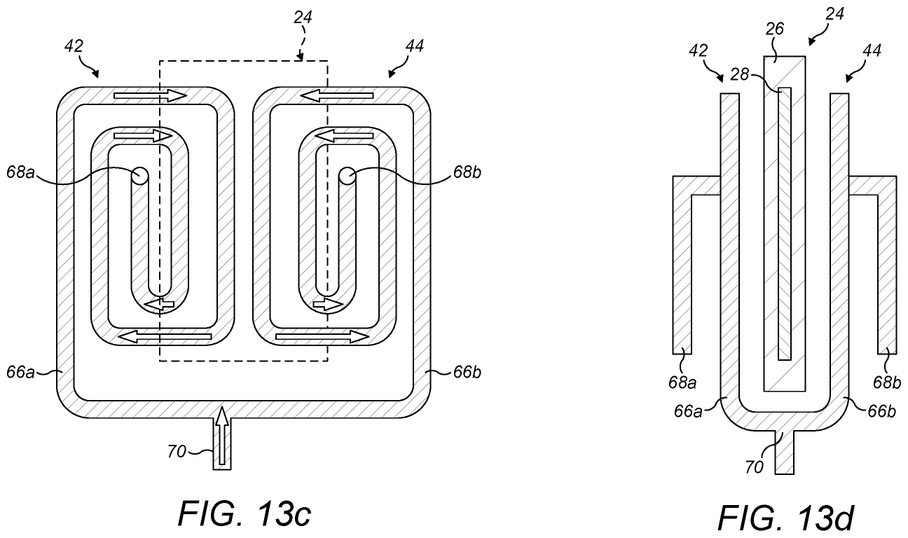

Referring to FIGS. 13a to 13d, there is shown a first electrical arrangement of first and second planar coils 42, 44 for use in the aerosol generating devices 10, 50 described above. The first planar coil 42 is illustrated in FIGS. 13a and 13b and includes a first electrode 66a and a second electrode 68a. The first planar coil 42 is wound in a clockwise direction as viewed in FIG. 13a from the first electrode 66a to the second electrode 68a. As best seen in FIGS. 13c and 13d, the second planar coil 44 has a similar structure to the first planar coil 42 and includes first and second electrodes 66b, 68b, but is wound in an anti-clockwise direction from the first electrode 66b to the second electrode 68b, in other words in an opposite direction to the first planar coil 42. The first and second planar coils 42, 44 are connected by a center tap 70, and more particularly the first electrodes 66a, 66b, are connected by the center tap 70 as shown in FIGS. 13c and 13d. With this electrical arrangement, the controller 20 can be configured to activate the first and second planar coils 42, 44 alternately (i.e. one at a time), for example by switching MOSFETs connected to each second electrode 68a, 68b. This causes current to flow in the first and second planar coils 42, 44 in opposite directions as indicted by the arrows in FIG. 13c, and more particularly causes current to flow in a clockwise direction in the first planar coil 42 as viewed in FIG. 13c from the first electrode 66a to the second electrode 68a, and in an anti-clockwise direction in the second planar coil 44 as viewed in FIG. 13c from the first electrode 66b to the second electrode 68b. This provides a desired heating effect when an aerosol generating article 24 is positioned between the first and second planar coils 42, 44 as shown in FIGS. 13c and 13d, for example in the heating chamber 22 of the aerosol generating device 10 described above.

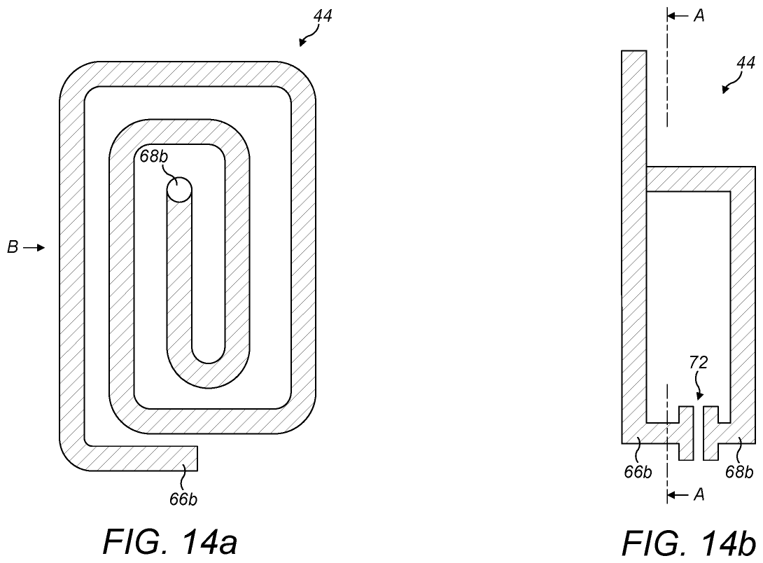

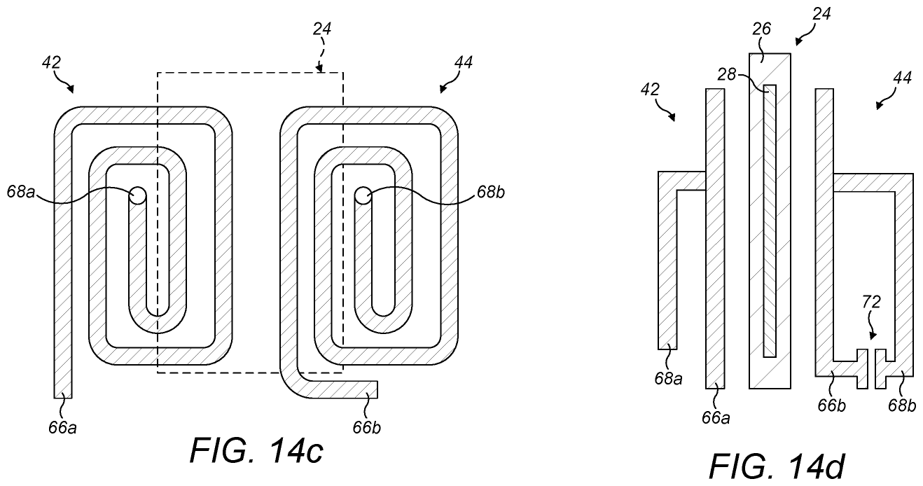

Referring to FIGS. 14a to 14d, there is shown a second electrical arrangement of first and second planar coils 42, 44 for use in the aerosol generating devices 10, 50 described above. The first planar coil 42, illustrated in FIGS. 14c and 14d, is as described above with reference to FIGS. 13a to 13d and comprises first and second electrodes 66a, 68a. The second planar coil 44 is similar to the first planar coil 42 shown in FIGS. 14c and 14d but includes a capacitor 72 positioned between first and second electrodes 66b, 68b. In this second electrical arrangement, the first planar coil 42 is an ‘active’ coil and the second planar coil 44 is a ‘passive’ coil.

In more detail, in operation the first planar coil 42 (‘active’ coil) is activated by the controller 20 by supplying electrical power from the power source 18 to the first and second electrodes 66, 68. This generates an electromagnetic field that penetrates the heating chamber 22 in a first direction and inductively heats an inductively heatable susceptor 28 of an aerosol generating article 24 positioned between the first and second planar coils 42, 44 as shown in FIGS. 14c and 14d, for example in the heating chamber 22 of the aerosol generating device 10 described above. During the period of activation of the first planar coil 42, the capacitor 72 of the second planar coil 44 (‘passive’ coil) is charged.

The first planar coil 42 is then deactivated by the controller 20 and the capacitor 72 of the second planar coil 44 is discharged, thereby causing the second planar coil 44 to generate an electromagnetic field that penetrates the heating chamber 22 in a different direction to the electromagnetic field generated by the first planar coil 42. The electromagnetic field generated by the second planar coil 44 inductively heats the inductively heatable susceptor 28 of the aerosol generating article 24 positioned between the first and second planar coils 42, 44 as shown in FIGS. 14c and 14d.

The first and second planar coils 42, 44 are activated repeatedly in the manner described above such that the capacitor 72 of the second planar coil 44 (‘passive’ coil) charges and discharges in counter-phase with the first planar coil 42 (‘active’ coil).

It will be understood by one of ordinary skill in the art that the electrical arrangements described above with reference to FIGS. 13 and 14 are provided by way of example only and that other suitable electrical arrangements could be adopted.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating system comprising an aerosol generating device and an aerosol generating article including aerosol generating material and an inductively heatable susceptor, wherein the aerosol generating device comprises:
an electromagnetic field generator including a first planar coil; and a second planar coil;
a heating chamber for receiving the aerosol generating article, the heating chamber being positioned between the first and second planar coils and including an air inlet and an air outlet; and
an airflow path extending between the air inlet and the air outlet.

2. The aerosol generating system according to claim 1, wherein the heating chamber includes an opening through which the aerosol generating article is inserted into the heating chamber.

3. The aerosol generating system according to claim 1, wherein the aerosol generating article is substantially plate-shaped, a cross-section of the heating chamber has major surfaces and side surfaces and the first and second planar coils are positioned outwardly of the major surfaces of the heating chamber.

4. The aerosol generating system according to claim 3, wherein the inductively heatable susceptor includes a major surface which is parallel with the major surfaces of the heating chamber.

5. The aerosol generating system according to claim 1, wherein the heating chamber includes projections or grooves for supporting the aerosol generating article in the heating chamber and for providing said airflow path around a surface of the aerosol generating article between the air inlet and the air outlet.

6. The aerosol generating system according to claim 1, wherein the electromagnetic field generator includes at least one additional planar coils, wherein the first, second, and at least one additional planar coils surround the heating chamber and are activated sequentially.

7. The aerosol generating system according to claim 1, wherein the heating chamber has a curved cross-sectional shape and the first and second planar coils lie on a curved plane surrounding the heating chamber.

8. The aerosol generating system according to claim 1, wherein the second planar coil includes a capacitor, electrical power is supplied intermittently to the first planar coil, and the first and second planar coils are arranged to face each other.

9. The aerosol generating system according to claim 1, wherein the second planar coil includes a capacitor and the aerosol generating device includes an electromagnetic shield positioned between the second planar coil and an outer cover.

10. The aerosol generating system according to claim 1, wherein the electromagnetic field generator is configured to supply electrical power to the first and second planar coils to cause current to flow in the first and second planar coils in opposite directions.

11. An aerosol generating device for heating an aerosol generating article including aerosol generating material and an inductively heatable susceptor, wherein the aerosol generating device comprises:
an electromagnetic field generator including a first planar coil and a second planar coil;
a heating chamber for receiving the aerosol generating article, the heating chamber being positioned between the first and second planar coils and including an air inlet and an air outlet; and
an airflow path extending between the air inlet and the air outlet.

12. The aerosol generating device according to claim 11, wherein the heating chamber includes an opening through which the aerosol generating article can be inserted into the heating chamber.

13. The aerosol generating device according to claim 11, wherein a across-section of the heating chamber has major surfaces and side surfaces and the first and second planar coils are positioned outwardly of the major surfaces of the heating chamber.

14. The aerosol generating device according to claim 11, wherein the heating chamber includes projections or grooves for supporting a plate-shaped aerosol generating article in the heating chamber and for providing said airflow path around a surface of the plate-shaped aerosol generating article between the air inlet and the air outlet.

15. The aerosol generating device according to claim 11, wherein the electromagnetic field generator includes at least one additional planar coil, wherein the first, second, and at least one additional planar coils surround the heating chamber and are configured to be activated sequentially.

16. A plate-shaped aerosol generating article comprising aerosol generating material and an inductively heatable susceptor positioned in the aerosol generating material.

17. The plate-shaped aerosol generating article according to claim 16, wherein the aerosol generating material comprises a foam material or one or more aerosol generating sheets.

18. The plate-shaped aerosol generating article according to claim 16, wherein the inductively heatable susceptor comprises a substantially planar susceptor element formed as an endless loop in a flat plane.

19. The plate-shaped aerosol generating article according to claim 16, wherein the inductively heatable susceptor comprises a plurality of substantially planar susceptor elements each formed as an endless loop in a respective flat plane.

20. The plate-shaped aerosol generating article according to claim 19, wherein the plurality of planar susceptor elements are distributed throughout the aerosol generating material.

21. The plate-shaped aerosol generating article according to claim 20, wherein a surface in which each of the plurality of planar susceptor elements lies is substantially parallel to major surfaces of the aerosol generating article.

22. The plate-shaped aerosol generating article according to claim 18, wherein the endless loop is polygonal.

23. The plate-shaped aerosol generating article according to claim 18, wherein the endless loop is curved.

24. The plate-shaped aerosol generating article according to claim 16, wherein the inductively heatable susceptor comprises a plurality of strips of susceptor material.

25. The plate-shaped aerosol generating article according to claim 24, wherein each of the plurality of strips has two parallel major faces and two end faces, and the plurality of strips are arranged so that their major faces are substantially parallel to major surfaces of the aerosol generating article.

26. The plate-shaped aerosol generating article according to claim 25, wherein the plurality of strips are aligned with each other within the aerosol generating material such that a normal direction to one of the major faces of each of the plurality of strips is directed in substantially a same direction.

27. The plate-shaped aerosol generating article according to claim 26, wherein the plurality of strips are spaced apart in a same plane between major edges of the aerosol generating article.

28. The plate-shaped aerosol generating article according to claim 26, wherein the plurality of strips are arranged in multiple planes between the major surfaces of the aerosol generating article.

29. The plate-shaped aerosol generating article according to claim 16, wherein the inductively heatable susceptor comprises a particulate susceptor material.
